(19) United States
(12) Patent Application Publication
(10) Pub. No.: US 2008/0002830 A1
(43) Pub. Date: Jan. 3, 2008

(54) Method, system, and computer-readable medium to maintain and/or purge files of a document management system

(76) Inventors: Aleksey G. Cherkasov, Covington, GA (US); Mikhail V. Domashchenko, Covington, GA (US)

Correspondence Address: Mclntyre Harbin & King, 500 Ninth Street SE, Washington, DC, 20003, US

(21) Appl. No.: 11/783,910

(22) Filed: Apr. 13, 2007

Related U.S. Application Data
(60) Provisional application No. 60/792,315, filed on Apr. 14, 2006.

(51) Int. Cl. G06F 17/00

(52) U.S. Cl. 380/277

(57) ABSTRACT

A method and corresponding apparatus and computer-readable medium to effect maintenance and/or purging of a document file in a multi-user document of file management system operating over a network. The document management system stores all document files in encrypted form. An exemplary method to assure full and complete purging of a document comprises generating an encryption key for the document, storing the encryption key in a central key storage accessible over the network by multiple users, producing an encrypted version of the document using the encryption key, storing the encrypted document in a central file storage medium, enabling a user to retrieve the document using the encryption key to decrypt the encrypted document when accessing the central file storage medium, and when necessary purging all copies of the document from the document management system by purging or deleting the encryption key.

### CROSS-REFERENCE TO RELATED PATENTS AND PATENT APPLICATIONS

This invention claims the benefit of Provisional Application Ser. No. 60/792,315 entitled “Document Management System, Method, and Computer-Readable Medium To Effect Implementation Thereof,” filed Apr. 14, 2006, which application in its entirety is incorporated by reference herein.

### BACKGROUND

This invention relates to computerized document/file management, but more specifically, to a method, system, and computer-readable medium to effectively purge a document in a multi-user document or file management system whether stored at a single or multiple sites of a network.

For legal or other reasons, it is often desirable to purge each copy or version of a file from storage at the end of its life-cycle. Effective purging becomes difficult in a multi-user environment where multiple copies may exist at separate and distinct physical file storage locations, or when copies of a file exist outside the control of enterprise management (e.g., when an individual user of the enterprise makes and stores elsewhere a work copy or backup copy of a document file on a CD-ROM or in another medium). Traditionally, a file was purged from a document management system by deleting the file, by overwriting the location in the storage medium embodying the file, or by deleting or overwriting reference to the file in a file allocation table of the storage medium. This may be achieved by accessing tables or indices identifying the location of the file (e.g., file allocation tables) and then deleting or altering the identifying information so that the file data becomes lost or overwritten. When multiple copies of the document or file exist in a networked file management system, for example, the location of each document or file must be found and each copy of the stored document or file must then be separately deleted at each of the multiple locations.

A problem encountered in purging a file in prior systems concerns the inability to track and locate multiple copies of an electronic document, particularly when many users of a local or wide area network access and use the same document. If a copy cannot be located or identified, that copy cannot be effectively purged. Very often, well after a document should have been purged according to a retention policy of the enterprise, a copy was subsequently discovered that unknowingly remained somewhere in the document management system or in the user's personal file storage system. Accidental retention beyond the retention period may have unwanted legal implications.

A prior system disclosed by U.S. Pat. Publication 2005/0076066 seeks to solve certain file retention problems by providing a “retention index file” identifying versioned copies of a document to be retained. The index is then processed according to a retention rule to determine whether the document is to be maintained. However, unless all other copies of the document were located, a copy may remain in the system despite the retention rule applied to the index.

The present invention seeks to solve the document purging problem in a multi-user document management or other type of file storage system.

### SUMMARY OF THE INVENTION

In accordance with the present invention, there is provided a method implemented in a document management system comprising generating an encryption key for a document file, producing an encrypted version of the document file using the encryption key, storing the encrypted document file and associated encryption key in a storage medium, and purging the document file by disabling effectiveness of the associated encryption key. Purging may be accomplished in any way to prevent recovery of the encryption key, such as by simply deleting the encryption key associated with a document or file.

In accordance with another aspect of the invention, there is provided a method of file management for use in a file management system where the method comprises generating an encryption key for a file, producing an encrypted version of the file using the encryption key, storing the encryption key and the encrypted version of the file in a storage medium, utilizing the encryption key to decrypt the encrypted version of the file for subsequent use by a user, and purging the file from the storage medium by purging the encryption key. This and other embodiments may further include transparently performing the generating, producing, and storing steps without intervention by a user.

In accordance with another aspect of the invention, there is provided a method of managing multiple copies of a document in a central storage medium of a multi-user document management system operating over a network where the method comprises generating an encryption key for the document, storing the encryption key in a central key storage accessible over the network by users of the system, producing an encrypted version of the document using the encryption key, storing the encrypted version of the document in the central storage medium of the multi-user document management system, enabling a user to retrieve the document by obtaining the encryption key from central key storage to decrypt the encrypted version of a document obtained from a storage medium, and when necessary, purging the document from the document management system by purging the encryption key.

In accordance with yet another aspect of the invention, there is provided a document management system comprising a network; a storage medium that communicates with the network; at least one client to obtain a file from the storage medium via the network; and a server in communication with the network where the server includes a processor to generate an encryption key associated with the file, to produce an encrypted version of the file using the encryption key, to store the encryption key and encrypted version of the file in the storage medium, and to effect purging of the file by purging the encryption key. The processor may also provide task scheduling to automatically purge one or more files according to a predetermined schedule or retention rule, or the processor may enable a user to initiate file purging sua sponte. In addition, the processor may inhibit dispatch or import of an encryption key to or from the document management system. If the encryption key is stored at multiple locations of the document management system, the processor may effect purging by providing a key deletion routine to purge one or more files by deleting associated encryption keys at each of the multiple locations.

In accordance with another aspect of the invention, there is provided a computer-readable medium implemented by a computer system to enable retrieval and/or purging of a file in a file management system where the medium embodies program instructions to effect action by a processor to generate an encryption key associated with the file, to produce an encrypted version of the file using the encryption key, to store the encryption key and encrypted version of the file in a storage medium, to enable retrieval and decryption of the file by a user using the encryption key, and to effect purging of the file by purging the encryption key. The medium may further embody program instructions to enable a user to purge a selected file; to automatically purge the file according to a predetermined schedule or retention policy; to inhibit dispatch of an encryption key from the document management system; and/or to inhibit storage of the file in a native or unencrypted format.

Any of the embodiments described herein may further include providing a task scheduler to automatically purge the document files according to a predetermined schedule or retention policy, or the user may initiate purging to purge a selected document file. In addition, any of the method embodiments described herein may further include inhibiting export of the encryption key from the document management system. In a further aspect, any of the methods may include storing the encryption key at multiple locations of a document management system where the purging step includes providing a key purging routine to purge the document file by purging the encryption key at each of the multiple locations. In addition, the methods may further include inhibiting storage of a document file in a native or unencrypted format. To provide increased security in document management, another feature of the method embodiments may include providing a fictitious name for the document file for storage in the storage medium or file allocation table thereof, providing a cross-referenced descriptive name for the document file, and providing a cross-reference between the fictitious and descriptive names to enable user access to the file by its descriptive name. A step of automatically performing encryption and decryption in background processing transparent to a user may be included in any of the methods.

The above and other aspects and features of the invention will become more readily apparent upon review of the following description taken in connection with the accompanying drawings. The invention, thought, is pointed out with particularity by the appended claims.

### BRIEF DESCRIPTION OF THE DRAWINGS

FIG. 1 shows a method of purging an electronic document according to one aspect of the present invention.

FIG. 2 shows a method of purging an electronic document according to another aspect of the present invention.

FIG. 3 shows a further, more detailed set of method steps of purging an electronic document according to yet another aspect of the present invention.

FIG. 4 shows an apparatus that may be used to carry out the methods shown in FIGS. 1-3 according to yet another aspect of the present invention.

### DESCRIPTION OF ILLUSTRATIVE EMBODIMENTS

Glossary of Terms

Document or Electronic Document refers to a piece of information having a defined lifecycle that is stored, managed, and finally purged from a document management system due to a document retention policy or other business reason. A document may be stored in a storage subsystem, such as a record in a database or a file in a file system, but the type of actual storage medium is irrelevant to the present invention.

Document Storage Medium refers to a physical medium where electronic documents or files are stored.

Purging or to purge is a process of destroying all copies of a document, piece of information, or other data. This includes physical removal, deletion, destruction, or permanently overwriting or masking of data from any and all kinds of storage media and/or making the data useless and unrecoverable, such as by overwriting or corrupting the data in a storage medium.

System refers to an abstract document, file, or content management system that controls the lifecycle of electronic documents. A document's life cycle starts upon creation, importation into or capturing of the document by the system and ends when the document is purged (or made unavailable) from the system. Encryption Key is a password or some other cipher code needed to decipher encoded data.

Encryption Algorithm refers to a procedure for performing encryption on data.

Through the use of an encryption algorithm, information is made into meaningless cipher text and requires the use of an encryption/decryption key to transform the data back into its original form. Blowfish, AES RC4, RC5, and RC6 are examples of algorithms requiring a key to encode and decode a data file. Keys may be symmetric, asymmetric, or elliptical. Encryption algorithms may also be opened or closed.

Key Storage is part of a system, external subsystem or another subsystem that keeps and maintains document encryption keys and references to documents.

User refers to a person or another system or piece of software that requires access to a document.

With the foregoing understanding, the present invention provides a novel approach to purge electronic documents or files from a document or content management system and may be implemented by software, hardware, or a combination of both. As indicated, many business reasons may dictate the desired lifecycle of electronic documents, such as regulatory requirements, HIPAA compliance, etc.

An illustrated embodiment of the present invention employs symmetric key cryptography (http://www.webopedia.com/TERM/S/symmetric_key_cryptography.html) to control the document lifecycle. Symmetric keys may be identical or complementary, depending on the algorithm employed. Documents are stored in the system in an encrypted form, and require a key to decrypt the document for any use thereof. Generally, a process according to the present invention of purging a document from a multi-user document management system (where multiple copies of the document may exist) includes deleting the encryption key associated with decrypting the document and/or deleting reference to the document in content storage. Access to and control of encryption/decryption keys and file reference information (e.g., file name, attributes, etc.) are managed by a system administrator or enterprise management. It is not intended that an individual user would have access to encryption/decryption keys, or even knowledge that such keys exist since a practicable aspect of the invention provides for performing encryption/decryption function in the background, transparent to the user.

In one embodiment of the invention, a document is stored by (i) automatically generating a new encryption key when the document is created or imported into the system, (ii) encrypting the document with the new key using a pre-defined encryption algorithm, (iii) storing an encrypted form of the document in a storage medium, and (iv) providing a Key Storage to store the encryption key, encryption algorithm (optionally), and reference to the document.

When a user requests retrieval of a document from the content storage system, a secondary retrieval process is implemented. An exemplary retrieval process comprises (i) obtaining the encrypted document from document storage; (ii) obtaining the encryption key from Key Storage and obtaining the encryption algorithm (if not locally available), (iii) supplying the encrypted document, encryption key, and encryption algorithm to a client device of a user, and (iv) decrypting the document using the encryption algorithm and the encryption key. If the encrypted document and algorithm are stored locally (or independently obtained from another source), the client device need only obtain the key from key storage via a server or other management system in order to decrypt and render the document on a display monitor or other I/O device. In a system where key storage is replicated among remote servers associated with a user, the user device need only obtain the key from its assigned local server.

Purging all copies of the document, wherever located, comprises purging or destroying the document's encryption/decryption key (and all possible copies of the key at the master server and any remote server, including any backup copy of the key) and/or deleting reference to the document in the Key Storage or elsewhere. Thereafter, the document becomes unrecoverable since there is no longer reference to the document or a key to decrypt it.

To add further security when the purging routine of the document management system runs on top of a conventional operating system (e.g., Windows, Linux, MacIntosh, etc.), the document management system may also convert the user-generated descriptive file name (e.g., Letter to John Smith) to a nonsensical alphanumeric or binary string (e.g., a fictitious name) for storage and file handling in the operating system environment under the nonsensical or fictitious name. As such, any residual file name that may remain in the operating system becomes meaningless and non-descriptive after deleting the corresponding encryption/decryption key.

This invention assumes that the document management system prevents or controls export/import of any encryption/decryption key. Also, the document management system does not permit storage of the document in any format other than in encrypted form. Preferably, all attributes of the document file, including its nonsensical or fictitious name, remain fixed and cannot be changed by a user. In a practicable application, encryption/decryption is performed locally on a client's computer in the background and is performed transparent to the user during document storage and retrieval cycles. The user need not and does not have access to key storage (unless, perhaps, when authoring a document and generating an encryption/decryption key). But even when authorizing or importing a document, the encryption key is automatically generated and applied to the document in a background processing operation in a way unknown and transparent to the user. Purging of the document may also be performed automatically by a task scheduling routine that implements a retention policy of the document management system, or alternatively, a system administrator may manually purge the document by deleting the encryption key from the key storage on an ad hoc or retention policy basis.

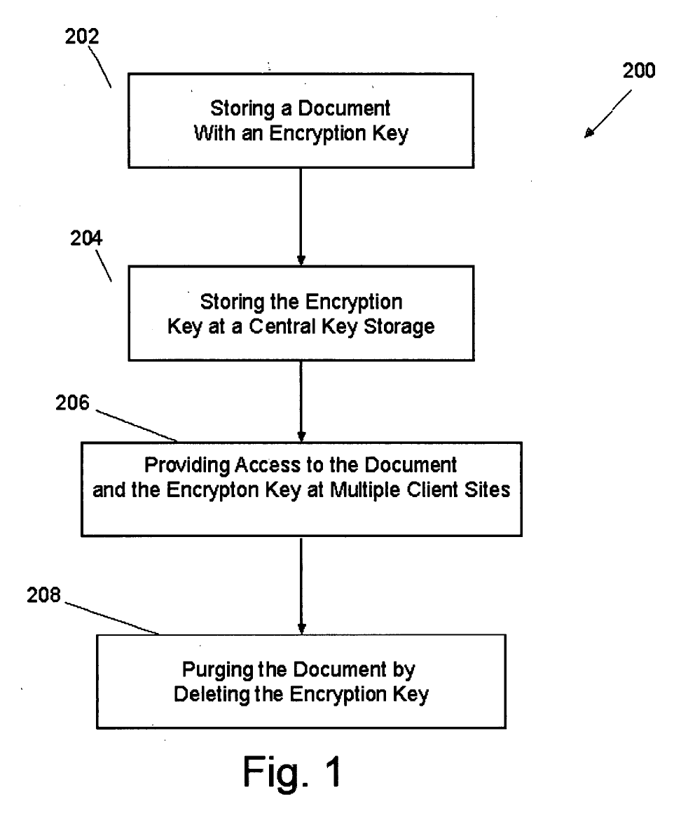

FIG. 1 shows an exemplary method 200 of purging a document from memory storage (such as a central storage facility of a document management system), which includes preliminary step 202 of storing a document and an associated encryption key used to encrypt and decrypt the document, step 204 of storing the encryption key in a memory device (which may be a central key storage file), step 206 of providing a user with access to the document and the encryption key, and step 208 of purging the document by deleting or otherwise purging the encryption key from central key storage file. Decryption (as well as access to the key) may be handled by a client device or network server, but preferably by the client device in order to reduce processing loads at the network server. If handled by the client, the client device retrieves the key from central storage upon access to the document file. In an alternative embodiment, the client may receive a fully decrypted file directly from the server, in which case the server will have performed the decrypting task on behalf of the requesting client device. Step 202 is typically performed by a system administrator in setting up the file or document management system, but may also be performed by a user during document importation. Once the encrypted documents and associated encryption keys are stored in the system, they may later be accessed by an end-user when subsequently handling document files of the file management system. Purging of documents is also typically performed by a system administrator in accordance with the policy of the business enterprise. A task scheduler may also be implemented to automatically purge documents in accordance with a predefined rule or policy. The actual purging of a document, as indicated herein, is simply performed by deleting, destroying, corrupting, overwriting, or purging the encryption key associated with the document.

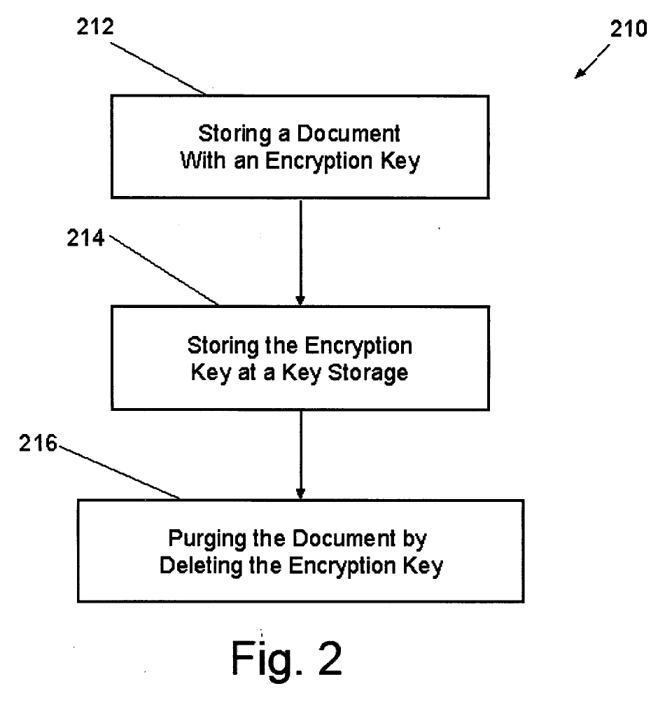

FIG. 2 shows a simplified method 210 of purging a file, which includes step 212 of storing a document and an associated encryption/decryption key, step 214 of storing the key in a key storage, and step 216 of purging the documents by deleting the encryption key. Since encrypted document file can only be accessed with its associated encryption key, purging the encryption key effectively purges the document file.

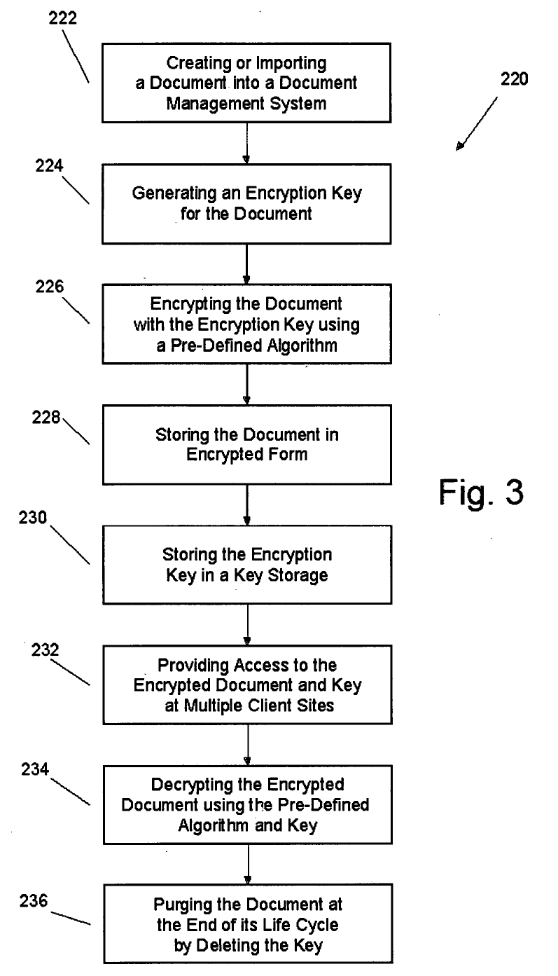

FIG. 3 illustrates a more extensive method including both document creation/importation as well as retrieval operations. The illustrated method 220 includes step 222 of creating or importing a document into a document management system, step 224 of generating an associated encryption/decryption key for the document thus created or imported, step 226 of encrypting the document with its associated key using a pre-defined encryption algorithm, step 228 of storing the document in encrypted form, step 230 of storing the encryption key in a key storage, step 232 of providing access to the encrypted document and key at multiple client sites, step 234 of decrypting the encrypted document using the pre-defined algorithm and key; and step 236 of purging the document at the end of its life cycle by deleting, or destroying the effectiveness of, the encryption key.

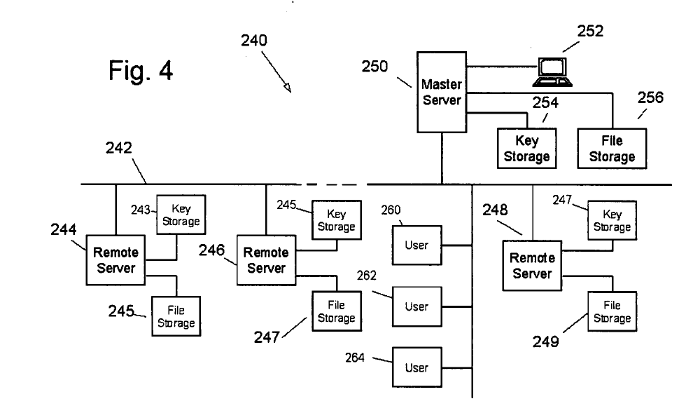

FIG. 4 shows an exemplary apparatus 240 that may be used to carry out any of the above-described methods or variations thereof. As shown, the apparatus or system includes a multi-user network 242 comprising a local area network (LAN), wide area network (WAN), a private network, wireless network, Internet, or combination of any such networks. Server 250 includes an administrator terminal 252, a file storage device 256 to store encrypted document files, and a key storage device 254 to store keys to unlock or decrypt document files stored in file storage 256. Multiple users 260, 262 and 264 communicate over network 242 and each of the users may be locally assigned or associated with any one of remote servers 244, 246, or 248, which may be controlled by a local administrator of the same enterprise that controls master server 250. Each remote server also includes an associated key storage 243, 245, or 247 that stores encryption/decryption keys and an associated file storage 245, 247, or 249 to store document files. The contents of either the key storage device 254 or file storage device 256 may be replicated among the remote servers. Deletion of an encryption key, or purging of a document file, is also replicated among these devices.

The master server 250 along with the remote servers 244, 246, and 248 and associated users 260, 262, and 264 implement a document management system over network 242 using server-side and client-side file management software. The software enables an exchange of information between the devices on the network. With appropriate permissions, a user 260, 262, or 264 may obtain a document file and its corresponding encryption key via its associated remote server (or directly from the master server 250 when no local key storage exists) in order to display or render the document image. Preferably, document files and encryption keys are replicated among the master and remote server devices so that a file and its associated key immediately remain at hand for ready access by a user.

When implementing document management functions, the apparatus 240 provides a user with document image files from file storage 256 or from file storage devices 245, 247, or 249 to multiple users that may be physically situated locally or at multiple distinct geographic locations. According to one embodiment of the present invention, a document image is stored in encrypted form in a file storage device, and either the master server 250 or a remote server effects a transfer of an associated key from a key storage device to the user in order to enable remote decryption of the document image. At the master or remote servers, the key storage and file storage may be grouped into a single information store having demarcated records, fields, or addresses; or they may be provided as separate information stores, as shown. If provided as separate stores, the key storage 254 may be physically located at a site different from the site of file storage 256. To perform encryption/decryption functions, any conventional algorithm may be employed as explained above. When a user desires to access the document, the document management system may also decrypt the encrypted document image centrally using the key from key storage 254, and then send the decrypted document image to the remote user for viewing on a display monitor at the client site.

Over time, use of the document management system during work flow or other processes may engender multiple copies of the document image stored in multiple storage devices 245, 247, or 249; or a copy of the document image might find its way to server 250. Wherever stored, the system restricts storage of the document image to the encrypted form only so that use of the key and pre-defined algorithm must be invoked in order to view or render the document image. In this manner, at the end of the document's life cycle, the document may be conveniently purged simply by deleting or rendering ineffective the document's associated encryption/decryption key from any key storage, which deletion is replicated at any other key storages in the system. Even though copies of the encrypted document may still reside on storage units 245, 247 and/or 249, and/or server 250, such encrypted copies are useless once the associated encryption/decryption key is purged from the key storage since the encrypted document can no longer be decrypted without deciphering/breaking the encryption code.

The document management system may optionally include a “housekeeping” function of periodically searching all accessible databases, identifying any documents that no longer have a valid encryption key, and then deleting (and optionally overwriting) those documents. This serves the function of preventing an eventual buildup and storage of needless files that have no valid encryption keys. This will reduce the amount of active storage required for the document management system.

Key storage 254 may reside at a central location or it may be replicated among remote servers across the network. Document purging may also be performed by a user/client or administrator depending on permissions associated with the document image. If the key storage is located centrally, deletion there at effectively purges the document. If, on the other hand, the key storage is replicated among remote sites, then a key deletion routine operates to delete the key associated with the deleted file at each key storage device of the remote servers. Encryption/decryption may also be performed with respect to embedded document annotations or their associated files. The technique and system described herein have application beyond document management systems, and may be deployed with text document, images, multimedia files, etc. Thus, the invention is not limited to the illustrated embodiments but instead embraces variations and adaptations that may come to those skilled in the art based on the teachings herein.

We claim:

1. A method implemented in a document management system comprising:
generating an encryption key for a document file,
producing an encrypted version of the document file using the encryption key,
storing the encrypted document file and associated encryption key in a storage medium, and
purging the document file by disabling effectiveness of the associated encryption key.

2. The method of claim 1, wherein said purging step comprises purging the encryption key.

3. The method of claim 2, wherein said purging step further includes providing a task scheduler to automatically purge said document file according to a predetermined retention policy.

4. The method of claim 1, further including enabling a user to initiate said purging step to purge a selected document file.

5. The method of claim 1, further including the step of inhibiting export of the encryption key from the document management system.

6. The method of claim 1, further including storing the encryption key at multiple locations of a document management system and said purging step includes providing a key purging routine to purge said document file by purging said encryption key at each of said multiple locations.

7. The method of claim 1, further comprising inhibiting storage of said document file in a native or unencrypted format.

8. The method of claim 1, further comprising providing a fictitious name for said document file for storage in a file allocation table of said storage medium, providing a descriptive name for said document file, and providing a cross-reference between said fictitious and descriptive names to enable user access to said file by said descriptive name.

9. The method of claim 8, further comprising purging the descriptive name so only fictitious name remains.

10. The method of claim 1, further comprising searching accessible databases, identifying any documents that no longer have an associated encryption key, and purging said identified documents whereby to remove needless files from the document management system.

11. A method of file management for use in a file management system, said method comprising:
generating an encryption key for a file,
producing an encrypted version of the file using the encryption key,
storing the encryption key and the encrypted version of the file in a storage medium,
utilizing the encryption key to decrypt the encrypted version of the file for subsequent use by a user, and
purging the file from the storage medium by purging the encryption key.

12. The method of claim 11, further comprising transparently performing said generating, producing, and storing steps without intervention by a user.

13. The method of claim 12, wherein said purging step comprises deleting the encryption key.

14. The method of claim 13, wherein said purging step further includes providing a task scheduler to automatically purge said file according to a predetermined schedule.

15. The method of claim 13, further including enabling a user to initiate said purging step to purge a file.

16. The method of claim 15, further including the step of inhibiting export of the encryption key from the file management system.

17. The method of claim 16, wherein the encryption key is stored at multiple locations of the management system and said purging step includes providing a key deletion routine to purge said file by deleting said encryption key at each of said multiple locations.

18. The method of claim 16, further comprising inhibiting storage of said file in a native or unencrypted format.

19. The method of claim 18, further comprising providing a non-descriptive fictional name for said file for storage in said storage medium, providing a cross-referenced descriptive name for said file, and providing a cross-reference between said fictional and descriptive names whereby to enable user access to said file by said descriptive name.

20. The method of claim 19, further comprising purging the descriptive name so only fictitious name remains.

21. The method of claim 13, further comprising searching said storage medium, identifying any documents that no longer have an associated encryption key, and purging said identified documents whereby to remove needless files from the file management system.

22. A method of managing multiple copies of a document in a central storage medium of a multi-user document management system operating over a network, said method comprising:
generating an encryption key for the document,
storing the encryption key in a central key storage accessible over the network by users of the system,
producing an encrypted version of the document using the encryption key,
storing the encrypted version of the document in the central storage medium of the multi-user document management system,
enabling a user to retrieve the document by obtaining the encryption key from central key storage to decrypt the encrypted version of a document obtained from the central storage medium, and
purging the document from the document management system by purging the encryption key.

23. The method of claim 22, further comprising enabling a user to selectively purge a document by purging an encryption key associated with the document.

24. The method of claim 22, further including automatically purging documents by purging associated encryption keys according to a predetermined schedule.

25. The method of claim 23, further including automatically performing encryption and decryption in background processing transparent to a user.

26. The method of claim 22, further comprising providing a key deletion routine to purge documents by replicating deletion of associated encryption keys at multiple key stores.

27. The method of claim 22, further comprising inhibiting a user from exporting or importing an encryption key relative to a file of the document management system.

28. The method of claim 22, further including inhibiting storage of documents of the document management system in a native or unencrypted format.

29. The method of claim 22, further comprising providing a fictional name for said document for storage in said storage medium, providing a descriptive name for said document in said document management system, and providing a cross-reference between said fictional and descriptive names whereby to enable user access to said file by said descriptive name.

30. The method of claim 29, further comprising purging the descriptive name so only fictitious name remains.

31. The method of claim 22, further comprising searching said central storage medium, identifying any documents that no longer have an associated encryption key, and purging said identified documents whereby to remove needless files from the document management system.

32. A document management system comprising:
a storage medium,
at least one client to obtain a file from said storage medium, and
a processor to generate an encryption key associated with said file, to produce an encrypted version of the file using the encryption key, to store the encryption key and encrypted version of the file in the storage medium, and to effect purging of the file by purging the encryption key.

33. The document management system of claim 32, wherein the processor provides task scheduling to automatically purge said file according to a predetermined schedule.

34. The document management system of claim 32, wherein said processor enables a user to initiate purging of said file.

35. The document management system of claim 32, wherein said processor inhibits export of an encryption key from the document management system.

36. The document management system of claim 32, wherein the encryption key is stored at multiple locations of the document management system and said processor effects purging by providing a key deletion routine to purge said file by deleting an encryption key at each of said multiple locations.

37. The document management system of claim 32, wherein said processor inhibits export of the encryption key from the document management system.

38. A computer-readable medium implemented in a computer system to enable retrieval or purging of a file in a file management system, said medium embodying program instructions to effect action by a processor to generate an encryption key associated with said file, to produce an encrypted version of the file using the encryption key, to store the encryption key and encrypted version of the file in a storage medium, to enable retrieval and decryption of the file by a user, and to effect purging of the file by purging the encryption key.

39. The computer-readable medium of claim 38, wherein said medium further embodies program instructions to enable a user to purge a selected file.

40. The computer-readable medium of claim 39, wherein said medium further embodies program instructions to automatically purge said file according to a predetermined schedule.

41. The computer-readable medium of claim 39, wherein said medium further embodies program instructions to inhibit export of an encryption key from the document management system.

42. The computer-readable medium of claim 39, wherein said medium further embodies program instructions to inhibit storage of the file a native or unencrypted format.
